(19) United States
(12) Patent Application Publication
(10) Pub. No.: US 2011/0100879 A1
(43) Pub. Date: May 5, 2011

(54) IMPROVEMENTS IN OR RELATING TO FILTERS

(76) Inventors: Alisdair Quentin Clark, Surrey (GB); Ricci Middleton, Surrey (GB); Peter Robert William Pugh, Surrey (GB)

(21) Appl. No.: 12/736,426

(22) PCT Filed: Apr. 3, 2009
(86) PCT No.: PCT/GB2009/000895

§ 371 Date: Dec. 21, 2010

(30) Foreign Application Priority Data
Apr. 8, 2008 (EP) 08251352.4

(51) Int. Cl. C10G 29/04; B03C 1/14

(52) U.S. Cl. 208/253; 210/695

(57) ABSTRACT

A magnetic filter device and method for using same, for removing ferromagnetic particles from a liquid, which device comprises a vessel having an inlet for liquid to flow into the vessel and an outlet for the liquid to flow out of the vessel, and the vessel having one or more magnets suspended therein for removing ferromagnetic particles from liquid flowing between the inlet and outlet, characterised in that: the vessel is a horizontal pipe with the inlet at one end and the outlet at the other end, the magnets are suspended transverse to the longitudinal axis of the pipe in one or more sets, and the vessel has one or more helical flow generators which in use, generate helical flow of the liquid as it flows between the inlet and outlet, and/or one or more turbulent flow generators which in use, generate turbulent flow of the liquid as it flows between the inlet and outlet. The helical and/or turbulent flow of the liquid may mitigate the potential problems of liquid and/or particles by-passing the magnet or magnets, for example arising from laminar flow of the liquid and/or uneven distribution of particles in the liquid.

This invention relates to filters and in particular, but not exclusively, to a magnetic filter device for removing ferromagnetic particles from liquids and to a method of using said device.

Magnetic filter devices are known for removal of ferromagnetic particles from liquids.

When a magnetic filter comprising one or more suspended magnets in a vessel is used to treat a liquid containing ferromagnetic particles problems may arise due to liquid and/or particles by-passing the magnets, for example arising from laminar flow of the liquid and/or uneven distribution of particles in the liquid. Thus, problems may arise, for example, if the liquid exhibits laminar flow as it passes through the vessel, because some of the liquid and/or particles may by-pass the magnets. This may be a problem if the particles are not evenly distributed in the liquid, for example if the particles settle in the liquid and hence by-pass the magnets in the vessel.

Thus, there is a need for a magnetic filter which overcomes or at least mitigates these problems.

Thus, according to the present invention there is provided a magnetic filter device for removing ferromagnetic particles from a liquid, which device comprises a vessel having an inlet for liquid to flow into the vessel and an outlet for the liquid to flow out of the vessel, and the vessel having one or more magnets suspended therein for removing ferromagnetic particles from liquid flowing between the inlet and outlet, characterised in that:
the vessel is a horizontal pipe with the inlet at one end and the outlet at the other end,
the magnets are suspended transverse to the longitudinal axis of the pipe in one or more sets, and
the vessel has one or more helical flow generators which in use, generate helical flow of the liquid as it flows between the inlet and outlet, and/or one or more turbulent flow generators which in use, generate turbulent flow of the liquid as it flows between the inlet and outlet.

The present invention solves the problem defined above by the use of one or more helical flow generators which generate helical flow of the liquid as it flows between the inlet and outlet and/or by the use of one or more turbulent flow generators which generate turbulent flow of the liquid as it flows between the inlet and outlet. The helical and/or turbulent flow of the liquid may mitigate the potential problems of liquid and/or particles by-passing the magnet or magnets, for example arising from laminar flow of the liquid and/or uneven distribution of particles in the liquid.

According to a first embodiment of the present invention there is provided a magnetic filter device for removing ferromagnetic particles from a liquid, which device comprises a vessel having an inlet for liquid to flow into the vessel and an outlet for the liquid to flow out of the vessel, and the vessel having two or more magnets suspended therein for removing ferromagnetic particles from liquid flowing between the inlet and outlet, the magnets being suspended in two or more sets which are in a common cross-sectional sector of the vessel and the vessel having one or more helical flow generators which in use, generate helical flow of the liquid as it flows between the inlet and outlet.

According to a second embodiment of the present invention there is provided a magnetic filter device for removing ferromagnetic particles from a liquid, which device comprises a vessel having an inlet for liquid to flow into the vessel and an outlet for the liquid to flow out of the vessel, and the vessel having one or more magnets suspended therein for removing ferromagnetic particles from liquid flowing between the inlet and outlet, the magnets being suspended in one or more sets and the vessel having one or more turbulent flow generators which in use, generate turbulent flow of the liquid as it flows between the inlet and outlet.

According to a third embodiment of the present invention there is provided a magnetic filter device for removing ferromagnetic particles from a liquid, which device comprises a vessel having an inlet for liquid to flow into the vessel and an outlet for the liquid to flow out of the vessel, and the vessel having one or more magnets suspended therein for removing ferromagnetic particles from liquid flowing between the inlet and outlet, the magnets being suspended in one or more sets and the vessel having one or more helical flow generators which in use, generate helical flow of the liquid as it flows between the inlet and outlet, and one or more turbulent flow generators which in use, generate turbulent flow of the liquid as it flows between the inlet and outlet.

The one or more helical flow generators generate helical flow of the liquid as it flows between the inlet and outlet. The helical flow of the liquid may enable liquid from different cross-sectional sectors in the vessel to contact at least one set of magnets as the liquid flows between the inlet and the outlet. This may prevent, or at least mitigate liquid and/or particles in one cross-sectional sector in the vessel by-passing the suspended magnets. For example, if the magnets are suspended in two or more sets in a common cross-sectional sector, the helical flow of the liquid may enable the liquid from different cross-sectional sectors in the vessel, to contact at least one set of magnets as the liquid flows between the inlet and the outlet. For example, if the magnets are suspended in two or more sets in a common cross-sectional sector, which is in the upper part of a horizontal vessel, the helical flow of the liquid may enable the liquid from different cross-sectional sectors including a lower cross-sectional sector in the vessel, to contact at least one set of magnets as the liquid flows between the inlet and the outlet. The use of helical flow generators may thus prevent, or at least mitigate the potential problems of liquid and/or particles by-passing the magnet or magnets, for example arising from laminar flow of the liquid and/or uneven distribution of particles in the liquid.

The helical flow generators generate helical flow of the liquid which may enable liquid from different cross-sectional sectors in the vessel to contact at least one set of magnets as it flows between the inlet and outlet. This may enable magnets which have lengths less than the diameter of the vessel to be used in two or more sets to contact liquid as it flows in a helix along the vessel. For example, magnets which have lengths which are only half the diameter of the vessel or less, could be used. This might prove useful if the pipe vessel is of very large diameter such that magnets with lengths which are more than half the diameter of the vessel might be excessively heavy, difficult to engineer or expensive. Also, this may have advantages if the liquid to be treated comprises two liquid phases, for example an aqueous phase and an organic phase, with the ferromagnetic particles predominately in the aqueous phase.

The helical flow generators may comprise one or more protuberances located on the wall of the vessel in a helix having a longitudinal axis in the direction of flow of the liquid.

The pitch of the helical flow may be less than the distance, in the direction of flow of the liquid, between sets of magnets in the vessel. The pitch of the helical flow may be greater than the distance, in the direction of flow of the liquid, between sets of magnets in the vessel. Preferably, the distance between sets of magnets in the direction of flow of the liquid is not a whole number multiple of the pitch of the helical flow. It will be understood that the direction of flow of the liquid referred to is the overall general direction of flow of the liquid and hence corresponds to the axis of the pipe.

The turbulent flow generators may comprise one or more protuberances located on the wall of the vessel. The turbulent flow generators may be located at or near the inlet of the vessel. The turbulent flow generators may be located in the vessel. The turbulent flow generators may be located upstream of the vessel. The turbulent flow generators may be located both in the vessel and up stream of the vessel. The turbulent flow generators generate turbulent flow of the liquid. This may mitigate the potential problems of liquid and/or particles by-passing the magnet or magnets. The turbulent flow generators may promote mixing of the ferromagnetic particles and the liquid. Such mixing may be vortex mixing and or back-mixing. Suitable turbulent mixers are available from Komax (trade mark). The use of turbulent flow generators may thus prevent, or at least mitigate the potential problems of liquid and/or particles by-passing the magnet or magnets, for example arising from laminar flow of the liquid and/or uneven distribution of particles in the liquid.

The vessel is a horizontal pipe which has an inlet at one end and an outlet at the other end, with the one or more magnets suspended transverse to the longitudinal axis of the pipe.

The one or more magnets are mounted transverse to the longitudinal axis of the pipe which corresponds to the general direction of flow of the liquid in the vessel. The sets of magnets may be mounted in the vessel along the axis of the direction of flow of liquid in the vessel. Thus, the device may have two or more sets of magnets suspended in the vessel along the longitudinal axis of the pipe. This may facilitate removal of the magnets from the vessel, for example for cleaning. If the vessel is mounted with the direction of flow of liquid in a horizontal plane, the magnets may be mounted vertically and transverse to the direction of flow of liquid in the vessel. Thus, the magnets may be suspended vertically and transverse to the longitudinal axis of the pipe. This is beneficial if the magnets are heavy and require lifting tackle to be removed.

The one or more magnets may be permanent magnets, for example rare earth permanent magnets. Each magnet may be mounted within a sleeve, for example, a stainless steel, austenitic stainless steel, ceramic or anodised aluminium sleeve. The sleeves may have a smooth surface, which may facilitate cleaning.

According to a further aspect of the present invention there is provided a method for removing ferromagnetic particles from a liquid which comprises passing the liquid through the device according to the present invention.

In use, the ferromagnetic particles accumulate on the magnets or on the sleeves, if the magnets are mounted in sleeves.

The liquid may be a fuel for example liquefied petroleum gas, automotive gasoline, aviation gasoline, kerosine, jet fuel, diesel fuel, marine fuel oil, residual fuel oil or other liquid fuel. The ferromagnetic particles may comprise iron oxide or ‘rust’. Iron or ‘rust’ may be formed by corrosion for example, of pipe-work, vessels and the like through which the liquid is passed, for example, during its manufacture, storage and/or distribution.

There is a need for liquid fuels to meet stringent specifications with regard to rust contamination and the present invention can assist in meeting such requirements.

The present invention will now be illustrated by way of example only with reference to the accompanying drawings in which

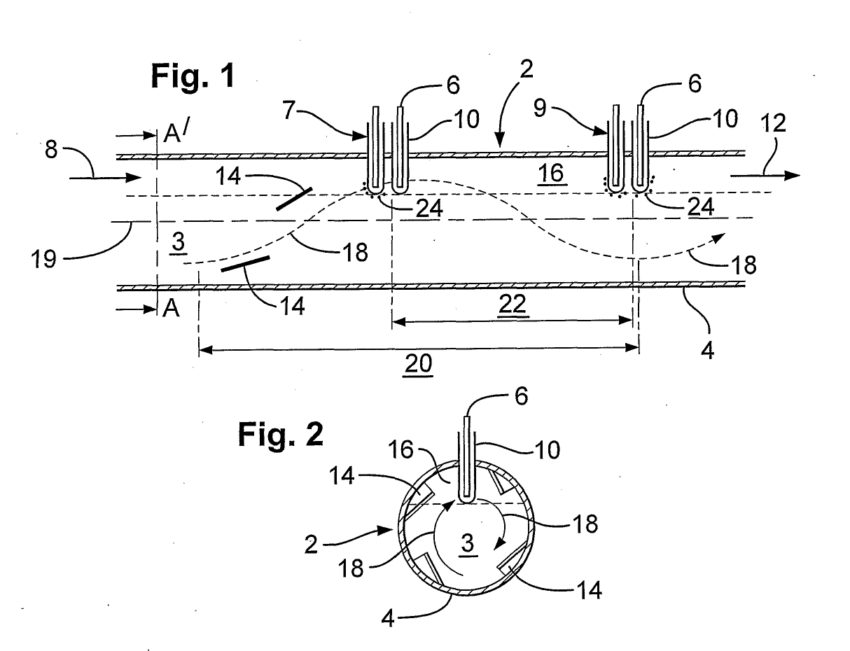

FIG. 1 shows in longitudinal part cross section, a magnetic filter device according to the present invention,

FIG. 2 shows a transverse cross section along line A-A′ of the device in FIG. 1 and

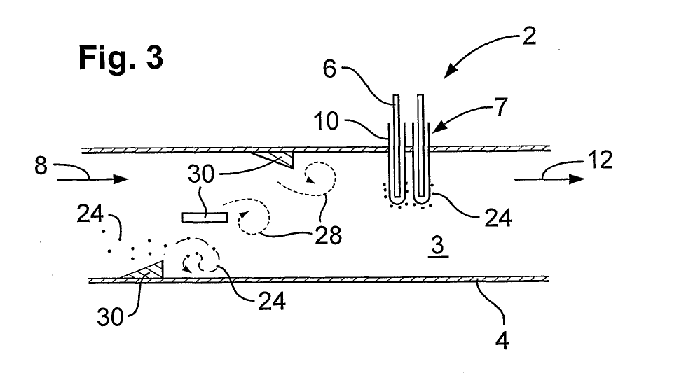

FIG. 3 is a longitudinal cross section of a magnetic filter device according to the present invention.

In FIGS. 1 and 2 the device 2 comprises a horizontal pipe vessel 4 having two or more magnets 6 suspended therein in two sets 7, 9. The magnets are mounted in sleeves 10. The vessel has an inlet 8 and outlet 12. In use liquid 3 flows from the inlet to the outlet and the ferromagnetic particles 24 accumulate on the sleeves 10 of the magnets 6. The sets 7, 9 of magnets 6 are in a common cross-sectional sector 16 of the vessel 4. The magnets shown in FIGS. 1 and 2 have lengths which are less than half the diameter of the pipe vessel. The vessel has a plurality of helical flow generators 14. In use, the helical flow generators cause the liquid to flow in a helical flow path 18 having a pitch 20 greater than the distance 22 in the direction of the liquid flow, between adjacent sets 7, 9 of the magnets in the vessel. It will be understood that the direction of flow of the liquid referred to is the overall general direction of flow of the liquid and hence corresponds to the axis 19 of the pipe 4. The distance between sets of magnets in the direction of flow of the liquid is not a whole number multiple of the pitch of the helical flow. This enables liquid from different cross-sectional sectors in the vessels to contact at least one set of magnets as the liquid flows between the inlet and the outlet. This may prevent, or at least mitigate the potential problems of liquid and/or particles by-passing the magnets, for example arising from laminar flow of the liquid and/or uneven distribution of particles in the liquid. The device may also have one or more turbulent flow generators (not shown).

FIG. 3 shows in longitudinal cross section a device according to the present invention having turbulent flow generators. In FIG. 3 the device 2, comprises a horizontal pipe vessel 4 having two or more magnets 6 suspended therein in at least one set 7. The magnets are mounted in sleeves 10. The vessel has an inlet 8 and outlet 12. In use liquid flows from the inlet to the outlet and the ferromagnetic particles 24 accumulate on the sleeves 10 of the magnets 6. The vessel has a plurality of turbulent flow generators 30. In use, the turbulent flow generators cause the liquid to flow in turbulent flow 28. The turbulent flow generators may promote mixing of the ferromagnetic particles and the liquid 3 and so may prevent, or at least mitigate the potential problems of liquid and/or particles by-passing the magnets, for example arising from laminar flow of the liquid and/or uneven distribution of particles in the liquid.

1.-14. (canceled)

15. A method for removing ferromagnetic particles from a liquid which method comprises passing the liquid through a magnetic filter device which comprises a vessel which is a horizontal pipe having:
an inlet at one end for liquid to flow into the vessel;
an outlet at the other end for the liquid to flow out of the vessel;
two or more magnets suspended therein for removing ferromagnetic particles from liquid flowing between the inlet and outlet, the magnets being suspended transverse to the longitudinal axis of the pipe in two or more sets along the longitudinal axis of the pipe; and
one or more helical flow generators,
which method comprises passing the liquid through the device and generating with the helical flow generators, helical flow of the liquid with a pitch such that the distance between the sets of magnets in the direction of flow of the liquid is not a whole number multiple of said pitch.

16. A method as claimed in claim 15 which comprises passing the liquid through a device in which the magnets are suspended in two or more sets which are in a common cross-sectional sector of the vessel.

17. A method as claimed in claim 15 which comprises passing the liquid through a device in which the helical flow generators comprise one or more protuberances located on the wall of the vessel in a helix having a longitudinal axis in the direction of flow of the liquid.

18. A method as claimed in claim 16 which comprises passing the liquid through a device in which the helical flow generators comprise one or more protuberances located on the wall of the vessel in a helix having a longitudinal axis in the direction of flow of the liquid.

19. A method as claimed in claim 15 which comprises passing the liquid through a device in which the magnets are suspended vertically and transverse to the longitudinal axis of the pipe.

20. A method as claimed in claim 16 which comprises passing the liquid through a device in which the magnets are suspended vertically and transverse to the longitudinal axis of the pipe.

21. A method as claimed in claim 18 which comprises passing the liquid through a device in which the magnets are suspended vertically and transverse to the longitudinal axis of the pipe.

22. A method as claimed in claim 15 which comprises passing the liquid through a device in which the lengths of the magnets are half or less of the diameter of the vessel.

23. A method as claimed in claim 16 which comprises passing the liquid through a device in which the lengths of the magnets are half or less of the diameter of the vessel.

24. A method as claimed in claim 20 which comprises passing the liquid through a device in which the lengths of the magnets are half or less of the diameter of the vessel.

25. A method as claimed in claim 15 in which the ferromagnetic particles comprise iron oxide.

26. A method as claimed in claim 16 in which the ferromagnetic particles comprise iron oxide.

27. A method as claimed in claim 20 in which the ferromagnetic particles comprise iron oxide.

28. A method as claimed in claim 24 in which the ferromagnetic particles comprise iron oxide.

29. A method as claimed in claim 15 in which the pitch of the helical flow is greater than the distance, in the direction of flow of the liquid, between sets of magnets in the vessel.

30. A method as claimed in claim 16 in which the pitch of the helical flow is greater than the distance, in the direction of flow of the liquid, between sets of magnets in the vessel.

31. A method as claimed in claim 20 in which the pitch of the helical flow is greater than the distance, in the direction of flow of the liquid, between sets of magnets in the vessel.

32. A method as claimed in claim 24 in which the pitch of the helical flow is greater than the distance, in the direction of flow of the liquid, between sets of magnets in the vessel.

33. A method as claimed in claim 28 in which the pitch of the helical flow is greater than the distance, in the direction of flow of the liquid, between sets of magnets in the vessel.

34. A method as claimed in claim 15 in which the liquid is a fuel which is liquefied petroleum gas, automotive gasoline, aviation gasoline, kerosine, jet fuel, diesel fuel, marine fuel oil or residual fuel oil.

35. A method as claimed in claim 33 in which the liquid is a fuel which is liquefied petroleum gas, automotive gasoline, aviation gasoline, kerosine, jet fuel, diesel fuel, marine fuel oil or residual fuel oil.
